(19) United States
(12) Patent Application Publication
(10) Pub. No.: US 2008/0235955 A1
(43) Pub. Date: Oct. 2, 2008

(54) Jab saw with accessible internal fastening location

(76) Inventors: Aaron Charles Rosso, Chicago, IL (US); Matthew Earle Myers, Naperville, IL (US); Scott Fong, Causeway Bay (HK)

Correspondence Address: GREER, BURNS & CRAIN, LTD., 300 SOUTH WACKER DRIVE, SUITE 2500, CHICAGO, IL, 60603, US

(21) Appl. No.: 11/731,979

(22) Filed: Apr. 2, 2007

(51) Int. Cl. B23D 49/10

(52) U.S. Cl. 30/166.3

(57) ABSTRACT

A jab saw has a blade and a handle. The blade has a piercing end and a handle end, separated by a cutting edge. The handle is configured for receiving the handle end and providing access to an internal fastening location after construction.

### BACKGROUND OF THE INVENTION

The present invention relates generally to hand tools and hand tool handles, and more specifically to jab saws for use in generally cutting soft materials such as wallboard.

Jab saws, which are available in various sizes, are used to manually cut shapes into wallboard and various other building panels including but not limited to wood. When using the jab saw, the shape to be cut is usually outlined onto the building panel. Next, the blade is aligned generally perpendicular to the panel surface. Then, the blade is pushed into the surface. A flat end on the back of handle is often provided as a striking area for the hand when additional force is required to coerce the plunge. Thumb and finger guards are also sometimes provided on the front of the handle for hand protection. After making the initial plunge cut, push and pull strokes are used to move the blade back and forth while simultaneously applying a lateral force to the handle to guide the path of the blade along the desired route.

Conventional jab saw handles are often heavy, bulky, difficult to grip and tiring to use over an extended period of time. Additionally, jab saws are generally either made with the handle directly molded to the blade or with the handle assembled to the blade prior to shipment of the saw. As an assembled jab saw requires greater packaging space than a disassembled saw, shipping costs are greater for assembled saws.

Consequently, there is a need for an improved jab saw that provides a light weight, strong gripping handle, and allows for the jab saw to be assembled after shipment, or remote from the point of manufacture.

### BRIEF SUMMARY OF THE INVENTION

The above-identified needs are met or exceeded by the present jab saw. To facilitate remote assembly, the present jab saw handle provides access to an internal fastening location so that the jab saw may be assembled after shipment and the assembly point of the blade to the handle is concealed post assembly. This feature addresses manufacturers' need to make efficient use of shipping space. Since homogenous parts can be packed more compactly, a container of only blades or only handles may be shipped at a lower cost and assembled at a remote location. In addition, the internal fastening location is concealable so that a user holding the handle will not be discomforted by the fastening location. Also, to increase control and grip, the present jab saw has an ergonomically shaped and soft gripping handle. Moreover, the handle is partially hollowed and provided with structural ribbing to provide a light yet sturdy handle.

More specifically, a jab saw includes a blade having a piercing end and a handle end, separated by a cutting edge. A handle is configured for receiving the handle end and providing access to an internal fastening location after construction.

In another embodiment, a jab saw includes a blade having a piercing end and a handle end separated by a cutting edge, the handle end having at least one fastener opening. A handle includes first and second housing halves configured for enclosing the handle end. The first and second housing halves include an exterior surface defining at least one recess providing access to an internal fastening location. The first and second housing halves define a cavity to accommodate the handle end, the at least one of first and second housing halves including at least one fastener constructed and arranged for entering through the internal fastening location and for engaging a corresponding fastener opening through the cavity for securing the handle to the handle end. At least one insert is configured for engaging a corresponding recess.

### BRIEF DESCRIPTION OF THE SEVERAL VIEWS OF THE DRAWINGS

FIG. 1 is an exploded perspective view of an embodiment of the present jab saw;

FIG. 2 is a side view of the handle of the assembled jab saw of FIG. 1;

FIG. 3 is a cross-section taken along the line 3-3 in FIG. 2 in the direction generally indicated;

FIG. 4 is a cross-section taken along the line 4-4 in FIG. 2 in the direction generally indicated; and

FIG. 5 is a cross-section taken along the line 5-5 in FIG. 2 in the direction generally indicated.

### DETAILED DESCRIPTION OF THE INVENTION

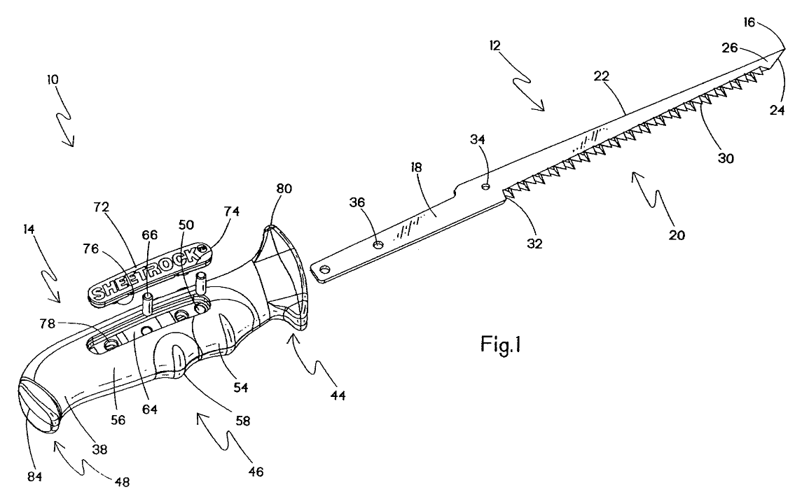

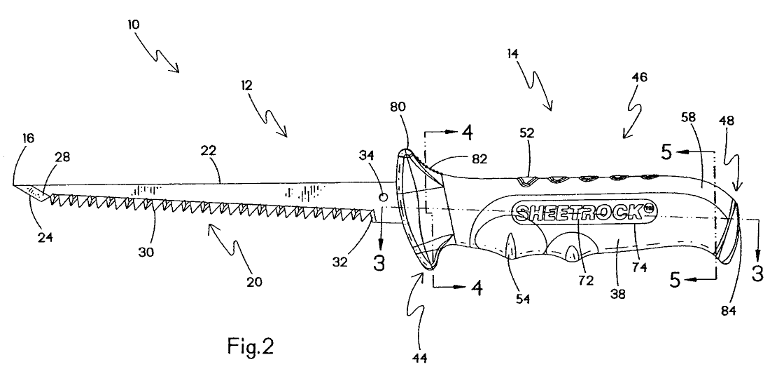

Referring now to FIGS. 1 and 2, the present jab saw is generally designated 10 and generally includes a blade 12 and a handle 14. Included on the blade 12 is a piercing end 16 and an opposite handle end 18, separated by a cutting edge 20. The piercing end is 16 distal to the handle 14, while the handle end 18 is proximal to the handle. In the preferred embodiment, the blade 12 is preferably thick, for added strength and to prevent lateral flexing during plunging and cutting. However, if the blade 12 is too thick, maneuverability as well as the ability to make an effective initial plunge into a surface may be compromised. The present blade 12 is preferably approximately 1.4-2.0 millimeters thick, with 1.8 millimeters especially preferred. Varying thicknesses are contemplated depending on the application. A typical blade 12 is 15.24-16.51 cm in length, however variations in blade length are envisioned. While other metals are contemplated as known in the art, the blade 12 is preferably made from hardened, tempered carbon steel and nickel-plated. An advantage of above-listed materials is to prolong blade sharpness.

As best seen in FIG. 2, the piercing end 16 is formed into a preferably sharp, elongated tip that allows for a plunge cut to effectively pierce the surface of a target material. While the preferred material is gypsum wallboard, the present saw 10 is contemplated for use in other similar construction boards and panels. A plunge cut is ordinarily made by jabbing the blade 12 generally perpendicularly to the surface of the material. The present piercing end 16 is generally wedge shaped with a top edge 22 generally perpendicular to a work piece surface to be pierced and a bottom edge 24 extending at an acute angle to the top edge. While the top edge 22 extends in a straight line from the piercing end 16 to the handle end 18, the bottom edge 24 extends a relatively short distance. A generally planar face 26 (FIG. 1) is located on one side of the piercing end 16, while a beveled portion 28 (FIG. 2) is located on the opposing side of the piercing end. The generally planar face 26 is generally perpendicular to the top edge 22. The beveled portion 28 slopes or tapers toward the piercing end 16. An advantage of the construction of the piercing end 16 is that a user may directly pierce a wallboard panel without initially drilling a starter hole.

The cutting edge 20 is located between the piercing end 16 and the handle end 18, with generally linearly arranged teeth 30 projecting generally normally to the top edge 22. Preferably, there are seven teeth 30 per inch along the cutting edge 20. It has been found that seven teeth 30 per inch allows for a fast, aggressive cut in softer materials such as wallboard. However, it is contemplated to have more teeth 30 per inch if the present blade 12 is needed to make a finer, slower cut for denser materials such as plastic. Also, a lower tooth density is contemplated for making coarse cuts as is known in the art. In the preferred tooth configuration, each tooth 30 has only one side sharpened, and teeth having edges sharpened on the same side are arranged alternately. Such a pattern has been found to yield a fast, aggressive cut but various other tooth patterns may be substituted. Additionally, the teeth 30 are relatively short, and preferably generally do not extend past an end portion 32 of the handle end 18, which facilitates cutting small circles and tight radii in a surface.

In the preferred saw 10, the handle end 18 has three openings; however the number of such openings may vary to suit the application. An optional center opening 34, located closest to the cutting edge 20, may be used for securing or immobilizing the blade 12 during handle installation; however it is more preferable to employ the opening as a fixture point in packaging the jab saw 10 or the blade.

At least one and preferably two fastener openings 36 (FIG. 1), located in the handle end 18, are used to fasten the blade 12 to the handle 14. The present fastener openings 36 are circular apertures located along the longitudinal axis of the handle end 18 but the number, shape and position of the fastener openings may vary.

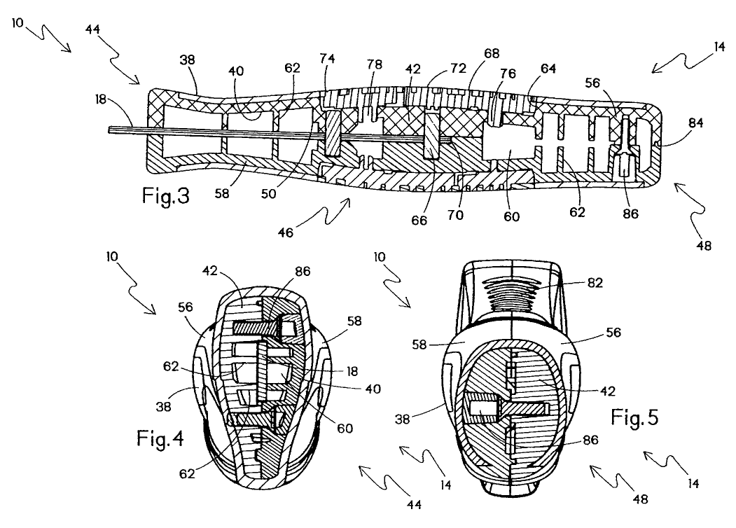

As seen in FIGS. 3-5, the handle 14 has an exterior surface 38 and an interior surface 40, separated by a handle core 42. Additionally, the handle 14 includes a first end 44, a middle portion 46, and a second end 48. The handle 14 is configured for receiving the handle end 18 and providing access to an internal fastening location 50 after construction.

As best seen in FIGS. 1-3, the handle 14 is designed for enhanced comfort and hand protection. At least a portion of the exterior surface 38 of the handle 14 is preferably made from a soft, rubber-like thermoplastic material known in the art for providing a resilient grip. A preferred resilient material has a Shore hardness of 65±5. As best seen in FIG. 3, the exterior surface 38 primarily envelops the middle portion 46. Portions of the handle 14 not covered with the resilient material are preferably made of a relatively harder thermoplastic material such as polypropylene with approximately 20% glass fiber. Other materials are contemplated as are well known in the art. The handle 14 is ergonomically shaped, with its exterior surface 38 complementing the shape of the palm and fingers of a user's hand when gripping the handle.

A plurality of generally elliptical protrusions 52 on a first side of the handle 14 corresponding to the upper blade edge or top edge 22, are preferably linearly arranged according to size, provide increased grip for the palm of the hand. A pair of hump-like projections 54 on the opposing side of the handle 14 nestle the fingers along the exterior surface 38. These features combine to provide a more positive grip between a user's hand and the exterior surface 38. As a result, the user is able to exert greater control and apply increased force over the handle 14 without the hand slipping. Other shapes for the handle 14 are contemplated, including but not limited to different numbers and types of the protrusions 52 and the hump-like projections 54. Between the exterior surface 38 and the interior surface 40 is a handle core 42 preferably made of a hard plastic material such as polypropylene with approximately 20% glass fiber, but various other materials exhibiting similar properties are contemplated.

As best seen in FIGS. 3-5, the handle 14 includes a first housing half 56 and a second housing half 58 for enclosing the handle end 18 of the blade 12 but alternatively may also be formed from a single housing or multiple housings. The two housing halves 56, 58 join along common edges generally located along a plane parallel to the blade 12. The handle 14 is provided with a cavity 60 for engaging or receiving the handle end 18. The cavity 60 is defined between the first and second housing halves 56, 58 axially along the length of the handle 14 and extends through the first end 44. It will be understood that the dimensions and placement of the cavity 60 may vary to suit the application.

As best seen in FIG. 3, to reduce material costs, the interior surface 40 of the handle 14 is partially hollow and has a plurality of transverse support ribs 62 perpendicular to the handle end 18. Hollowing the handle 14 reduces weight while the ribbing 62 provides sufficient structural support. As seen best in FIG. 4, the internal ribs 62 of the handle 14 abut the handle end 18 of the blade 12 to provide additional support and structural integrity upon assembly of the saw 10. The handle end 18 is preferably centrally and axially aligned in the handle 14. The lighter weight of the handle 14 decreases user fatigue, enhances saw balance and increases comfort.

As best seen in FIG. 1, the exterior surface 38 of the handle 14 defines at least one recess 64 configured for providing user access to the internal fastening location 50. The recess 64 may also be configured for allowing access to a portion of the handle end 18. An advantage of the recess 64 is that the handle 14 can be constructed remotely from the blade 12 for achieving a postponed assembly of the blade to the handle. In some cases, manufacturers need to make efficient use of shipping space of saw components. Since homogenous parts can be packed more compactly, a container of only blades or only handles is desirable.

In the preferred embodiment, only one of the first and second housing halves, which are asymmetrical, will be provided with the at least one recess 64. Alternatively, both asymmetrical housing halves 56, 58 may have recesses 64 but only one of the recesses may allow access to the internal fastening location 50 (FIG. 3). It is contemplated that if both recesses 64 provide access to the internal fastening location 50, both housing halves 56, 58 are symmetrical.

In the present jab saw 10, the recess 64 is located on the first housing half 56. The recess 64 is elliptical in shape and positioned approximately axially along the exterior surface 38 of the first housing half 56. The recess 64 is also dimensioned to have sufficient depth to allow access to the internal fastening location 50 and for fasteners 66 to be secured to fastener openings 36 in the blade 12.

Referring to FIGS. 1 and 3, included on the handle 14 is at least one fastener 66 constructed and arranged for engaging at least one corresponding fastener opening 36 through the cavity 60 at the internal fastening location 50 for securing the handle 14 to the handle end 18. Fasteners 66 may include pins, screws, nails, rivets, clamps, hooks, latches, cables, chemical adhesives, ultrasonic welding and any conventional equivalents. In the present jab saw 10, the fasteners 66 are two pins received in the internal fastening location 50, preferably configured as open end sockets 68 in the first housing half 56 and blind end sockets 70 in the second housing half 58. The sockets 68, 70 are dimensioned to receive the respective pins 66 with a tight friction fit. The fastener openings 36 in the handle end 18, preferably defined by apertures, are also dimensioned for receiving the pins 66 with a tight friction fit. An advantage of this structure is that the pins 66 will be properly located and more securely retained in the handle 14 and the blade 12; and the pins will be prevented from being pushed in excessively deep into the handle during installation. However, it is contemplated to have housing halves 56, 58 with sockets 68, 70 penetrating entirely through both housing halves or to use other types of fasteners 66. It is preferable that, upon assembly, the fasteners 66 are perpendicular to the handle end 18 and adjoining edges of the two housing halves 56, 58.

Additionally, there is at least one insert 72 configured for engaging the corresponding recess 64 with a tight friction fit. In the present jab saw 10, the recess 64 is of sufficient depth to allow the inserted fasteners 66 to be covered by the insert 72. The insert 72 is dimensioned to complement the shape of the recess 64 and have a circumferential lip 74 that is generally flush with the exterior surface 38 so that a user is not discomforted from holding the handle 14. Further details of the construction of the insert are provided in commonly assigned copending U.S. patent application Ser. No. 11/328,530 filed Jan. 10, 2006, which is incorporated by reference.

To additionally secure the insert 74 in the recess 64, at least one and preferably a pair of lugs 76 are provided on the bottom of the insert to matingly engage holes 78 inside the recess. It will be understood that the holes 78 may be provided to the insert 72 and the lugs 76 to the recess 64, and other fastening techniques for securing the insert to the recess are contemplated. Thus, the insert 72 is designed and configured to not only provide a safe and comfortable grip for the user but also to conceal the internal fastening location 50 after the blade 12 has been secured to the handle 14.

Returning to FIGS. 1 and 2, the first end 44 of the handle 14 is positioned to point towards the piercing end 16 and includes a finger guard 80 configured for protecting a user's hand. The finger guard 80 flares outward in a direction perpendicular to the longitudinal axis of the handle 14. A plurality of generally parallel grooves 82 (FIG. 2) or other textural surface is provided to enhance grip along the surface in contact with the thumb.

The second end 48 of the handle 14 is oriented to point away from the piercing end 16 of the blade 12 and is provided with a striking area 84. The striking area 84 is generally flat and can be stricken with the palm of the hand or a similar object to help push the jab saw 10 through a receiving wallboard panel or the like.

Referring now to FIGS. 3-5, end fasteners 86 are provided to additionally secure the first and second housing halves 56, 58. The end fasteners 86 may include pins, screws, nails, rivets, clamps, hooks, latches, cables, chemical adhesives, ultrasonic welding and any conventional equivalents. In the preferred embodiment, two end fasteners 86 are located near the finger guard 80 on the first end 44, and one end fastener is located near the second end 48.

In operation, when using the jab saw 10, a user first outlines the shape sought to be cut into the material. Next, the user aligns the blade 12 of the jab saw 14 generally perpendicular to the surface. Then, the user pushes the blade 12 into the surface, hitting the striking area 84 if additional force is needed. After making the initial plunge cut, the user applies push and pull strokes to move the blade 12 back and forth while simultaneously applying a lateral force to the handle 14 so as to guide the path of the blade 12 along the desired route.

While a particular embodiment of the present jab saw has been described herein, it will be appreciated by those skilled in the art that changes and modifications may be made thereto without departing from the invention in its broader aspects and as set forth in the following claims.

What is claimed is:

1. A jab saw comprising:
a blade having a piercing end and a handle end, separated by a cutting edge; and
a handle configured for receiving said handle end and providing access to an internal fastening location after construction.

2. The saw according to claim 1, wherein said handle end has at least one fastener opening and said handle is provided with a cavity for engaging said handle end, and said handle includes at least one fastener constructed and arranged for entering through said internal fastening location and for engaging a corresponding one of said at least one fastener opening through said cavity for securing said handle to said handle end.

3. The saw according to claim 1, wherein an exterior surface of said handle defines at least one recess.

4. The saw according to claim 3, wherein said at least one recess is configured for providing user access to said internal fastening location.

5. The saw according to claim 3, further including at least one insert configured for engaging corresponding one of said at least one recess.

6. The saw according to claim 1, wherein said handle includes first and second housing halves, joinable along common edges, said first half being asymmetrical relative to said second half.

7. The saw according to claim 6, wherein one of said first and second housing halves has an exterior surface defining at least one recess.

8. The saw according to claim 1, wherein said handle has an interior surface having ribs.

9. The saw according to claim 8, wherein said handle has an exterior surface including a relatively resilient, grip enhancing material.

10. The saw according to claim 1, wherein said handle has a first end positioned to point towards said piercing end, and said first end includes a finger guard configured for protecting a user's hand.

11. The saw according to claim 10, wherein said handle has a second end positioned to point away from said piercing end, and is provided with a striking area.

12. A jab saw comprising:
a blade having a piercing end and a handle end, separated by a cutting edge, said handle end having at least one fastener opening;
a handle including first and second housing halves configured for enclosing said handle end;
said first and second housing halves including an exterior surface defining at least one recess providing access to an internal fastening location;
said first and second housing halves defining a cavity to accommodate said handle end, said at least one of first and second housing halves including at least one fastener constructed and arranged for entering through said internal fastening location and for engaging a corresponding one of said at least one fastener opening through said cavity for securing said handle to said handle end; and
at least one insert configured for engaging a corresponding one of said at least one recess.

13. The saw according to claim 12, wherein said at least one fastener is at least one pin, and said at least one fastener opening is at least one aperture dimensioned to receive said at least one pin with a tight friction fit.

14. The saw according to claim 12, wherein said first and second housing halves include ribbed interior surfaces abutting said handle end.

15. The saw according to claim 12, wherein said first and second housing halves are joinable along common edges, said first housing half being asymmetrical relative to said second housing half.

16. The saw according to claim 12, wherein said recess is configured for allowing access to said handle end.

17. A jab saw comprising:
a blade;
a handle constructed remotely from said blade; and
a means for achieving postponed assembly of said blade to said handle.

18. The saw according to claim 17, wherein said blade includes a piercing end and a handle end, separated by a cutting edge, said handle end having at least one fastener opening;
said handle including first and second housing halves configured for enclosing said handle end, said first and second housing halves including an exterior surface defining at least one recess providing access to an internal fastening location;
said first and second housing halves defining a cavity to accommodate said handle end, said at least one of first and second housing halves including at least one fastener constructed and arranged for entering through said internal fastening location and for engaging a corresponding one of said at least one fastener opening for securing said handle to said handle end;
and at least one insert configured for engaging a corresponding one of said at least one recess.

19. The saw according to claim 18, wherein said first and second housing halves are joinable along common edges, said first housing half being asymmetrical relative to said second housing half.

20. The saw according to claim 18, wherein said first and second housing halves include ribbed interior surfaces.
